(19) United States
(12) Patent Application Publication
(10) Pub. No.: US 2026/0362305 A1
(43) Pub. Date: Nov. 12, 2026

(54) METHODS, ARCHITECTURES, APPARATUSES, AND SYSTEMS FOR AIoT DEVICE COMMUNICATION IN A WIRELESS NETWORK

(71) Applicant: InterDigital Patent Holdings, Inc., Wilmington, DE (US)

(72) Inventors: Guanzhou Wang, Brossard (CA); Michael Starsinic, Newtown, PA (US); Anuj Sethi, Ottawa (CA); Mohamad Kenan Al-Hares, Canterbury (GB)

(21) Appl. No.: 19/202,583

(22) Filed: May 8, 2025

(51) Int. Cl. H04W 48/18; H04L 67/12

(52) U.S. Cl. CPC H04W 48/18; H04L 67/12

(57) ABSTRACT

Procedures, methods, architectures, apparatuses, systems, and devices are provided for communicating with ambient-power-enabled internet of things (AIoT) devices in wireless networks. A method performed by a wireless transmit/receive unit (WTRU) includes receiving, from a wireless network, configuration information indicating at least one AIoT service area, determining that the WTRU is located within an AIoT service area of the at least one AIoT service area, based on determining that the WTRU is located within the AIoT service area, transmitting, to the wireless network, information including an indication that the WTRU is located within the AIoT service area, receiving, from the wireless network, an AIoT service request associated with the AIoT service area, and causing an operation to be performed based on the AIoT service request.

### TECHNICAL FIELD

The present disclosure is generally directed to the fields of communications, hardware, software and encoding, including, for example, to methods, architectures, apparatuses, and systems related to wireless transmit/receive unit (WTRU) devices in communication with ambient internet of things (AIoT) devices in wireless networks.

### BACKGROUND

Ambient internet of things (AIoT) devices can harvest energy from the environment, such as wireless radio waves, motion, vibration, piezoelectricity, solar and wind power, other suitable environmental power sources, or any combination thereof. They are often battery-less and have limited energy storage (e.g., based on the capacity of a capacitor). AIoT devices often find use in industrial wireless senor networks with harsh environments (e.g., extremely high or low temperature). Such applications may be best served by AIoT devices that are battery-less, maintenance-free, and offering long service lifetimes.

Because of these constraints, AIoT devices are limited in how they can communicate with wireless networks.

### SUMMARY

In connection with certain representative embodiments of this disclosure, a WTRU may perform reader functionality, including communicating with an AIoT device such that information from the AIoT device can be shared with a wireless network to which the WTRU is communicatively coupled. Because WTRUs and AIoT devices may be mobile, existing wireless network operations may lack approaches to readily identify one or more WTRUs that can service specific AIoT service areas. Accordingly, in connection with certain representative embodiments of this disclosure, methods and WTRUs are provided for indicating that the WTRU is located within an AIoT service area and for performing operations (e.g., in the AIoT service area) based on AIoT service request.

Procedures, methods, architectures, apparatuses, systems, and devices are provided for communicating with AIoT devices in wireless networks. A method performed by a wireless transmit/receive unit (WTRU) includes receiving, from a wireless network, configuration information indicating at least one ambient-power-enabled internet of things (AIoT) service area, determining that the WTRU is located within an AIoT service area of the at least one AIoT service area, based on determining that the WTRU is located within the AIoT service area, transmitting, to the wireless network, information including an indication that the WTRU is located within the AIoT service area, receiving, from the wireless network, an AIoT service request associated with the AIoT service area, and causing an operation to be performed based on the AIoT service request.

In certain representative embodiments, the operation includes receiving, using an over-air interface, device data from at least one AIoT device, and providing the device data to the wireless network.

In certain representative embodiments, the transmitted information also includes the AIoT service area.

In certain representative embodiments, determining that the WTRU is located within the AIoT service area includes determining that the WTRU is located within the AIoT service area according to a timer. In certain representative embodiments, the timer is a first timer, a first periodic determination based on the first timer causes the WTRU to determine whether the WTRU has left the AIoT service area, and a second periodic determination based on a second timer causes the WTRU to determine whether the WTRU has entered the AIoT service area

In certain representative embodiments, determining that the WTRU is located within the AIoT service area is based on a WTRU mobility event occurring.

In certain representative embodiments, the AIoT service area includes multiple levels, and the information further includes a particular level of the multiple levels

In certain representative embodiments, the method also includes requesting the configuration information.

In certain representative embodiments, the AIoT service request includes a WTRU identifier, and causing the operation to be performed is further based on determining that the WTRU identifier is associated with the WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system, in accordance with some embodiments of this disclosure;

FIG. 1B is a system diagram illustrating an example wireless transmit and/or receive unit (WTRU) that may be used within the communications system illustrated in FIG. 1A, in accordance with some embodiments of this disclosure;

FIG. 1C is a system diagram illustrating an example radio access network (RAN) and an example core network (CN) that may be used within the communications system illustrated in FIG. 1A, in accordance with some embodiments of this disclosure;

FIG. 1D is a system diagram illustrating a further example RAN and a further example CN that may be used within the communications system illustrated in FIG. 1A, in accordance with some embodiments of this disclosure;

FIG. 2 is a pair of illustrative system diagrams of components implementing the features of an ambient internet of things (AIoT) function and an AIoT application function, in accordance with some embodiments of this disclosure;

FIG. 3 is an illustrative system diagram of a first wireless network architecture including an AIoT device, in accordance with some embodiments of this disclosure;

FIG. 4 is an illustrative system diagram of a second wireless network architecture including an AIoT device and a WTRU operating as a reader device, in accordance with some embodiments of this disclosure;

FIG. 5 is an illustrative diagram of a multi-level AIoT service area, in accordance with some embodiments of this disclosure;

FIG. 6 is a flow diagram of an illustrative process of a WTRU reporting its location as being within an AIoT service area, in accordance with some embodiments of this disclosure;

FIG. 7 is a flow diagram of an illustrative process of a core network transmitting an AIoT service request and a WTRU causing operations to be performed based on the AIoT service request, in accordance with some embodiments of this disclosure; and

FIG. 8 is a flow diagram of an illustrative process of a WTRU receiving an AIoT service request and causing operations to be performed based on the AIoT service request, in accordance with some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known processes, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

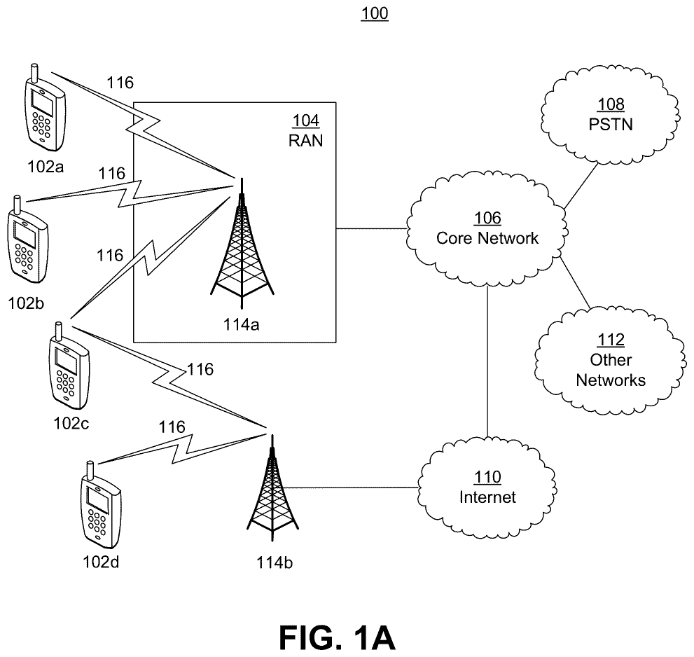

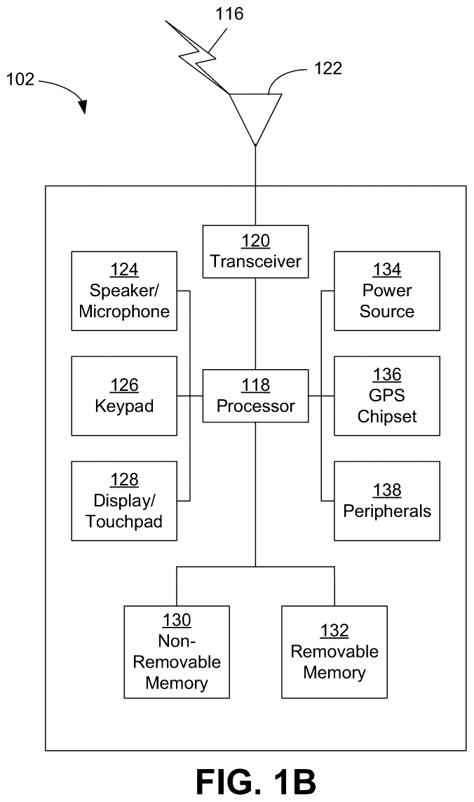

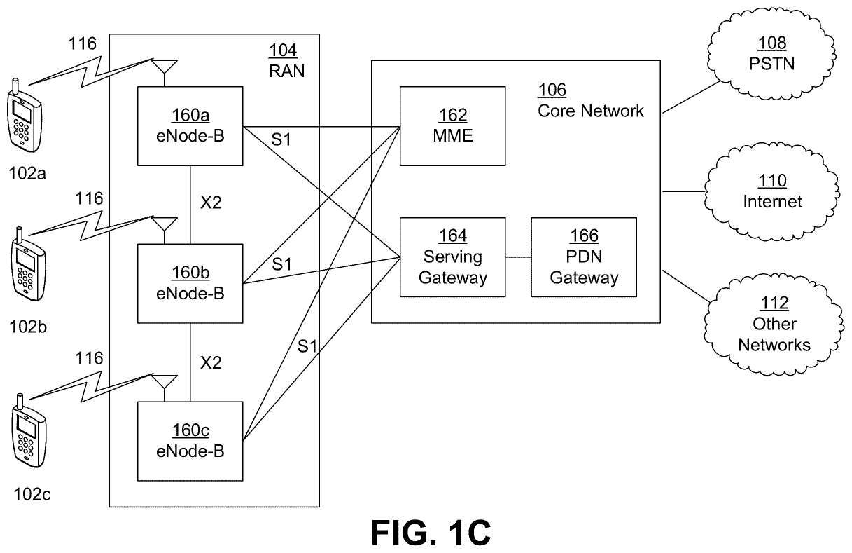

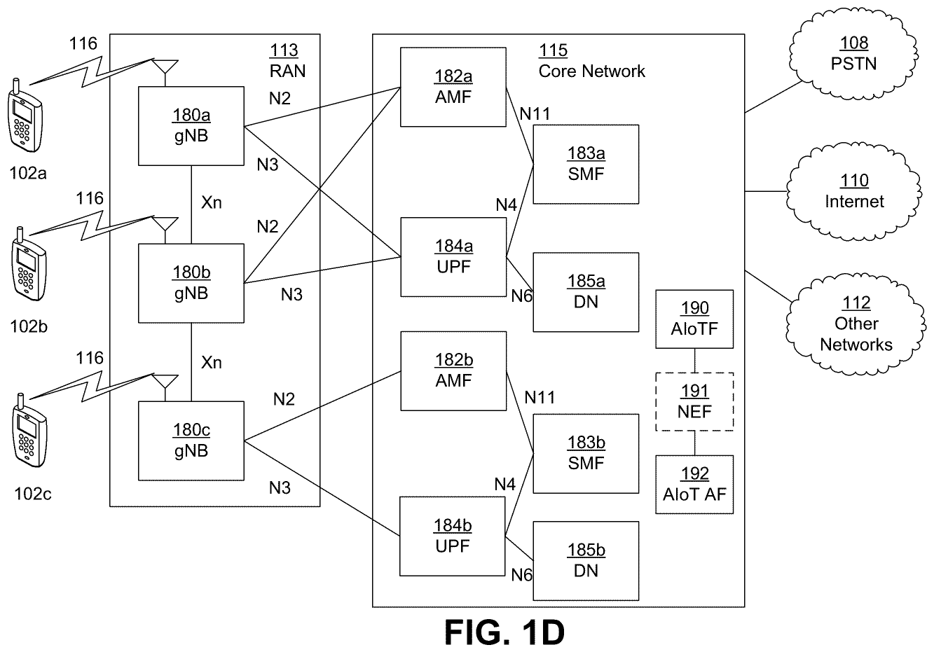

The processes, apparatuses and systems provided herein are well-suited for communications involving both wired and wireless networks (which may be referred to more succinctly as networks). An overview of various types of wireless devices and infrastructure is provided at least in connection with FIGS. 1A-1D, where various elements of the network may utilize, perform, be arranged in accordance with and/or be adapted and/or configured for the processes, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access processes, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa. Any of the WTRUs 102a, 102b, 102c and 102d may perform UE reader functionality, as further described below.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. For example, the location information may be used to determine that a WTRU is located within an AIoT service area. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination process while remaining consistent with an embodiment. Moreover, the WTRU 102 may receive device data (e.g., location, orientation, height, environmental data, or any other data) from any one or more AIoT devices (e.g., AIoT device 301 or AIoT device 401) over the air interface 116.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, at least one Data Network (DN) 185a, 185b, at least one ambient internet of things function (AIoT) 190, and at least one ambient internet of things application function (AIoT AF) 192. Optionally, AIoT 190 may be coupled to AIoT AF 192 by network exposure function (NEF) 191. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

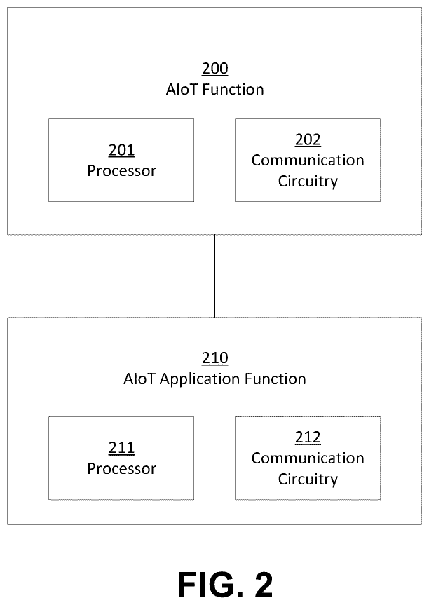

In view of the descriptions provided in connection with FIGS. 1A-1D, and further in view of the following descriptions provided in connection with FIGS. 2-8, it will be understood that a wireless network may include any suitable components and devices, including, for example, any of one or more base stations, one or more TRPs, one or more gNBs, one or more WTRUs, one or more AIoT devices, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

In view of the descriptions provided in connection with FIGS. 1A-1D, and further in view of the following descriptions provided in connection with FIGS. 2-8, a node (e.g., of a wireless network) may generally refer to any physical component that communicates with any other physical component of a wireless network. For example, any physical component performing functions of the RAN or CN may be a node, a gNB may be a node, an eNB may be a node, a WTRU may be a node, a base station may be a node, a DNS server may be a node, and any other equipment configured to communicate with and/or provide a function of the wireless network may be a node. A node may be used interchangeably with an entity or device of the wireless network. In some instances, multiple aspects of the wireless network (e.g., a DNS server and equipment providing at least one function of the network, equipment providing multiple functions of the wireless network, or equipment providing multiple instances of a single function of the wireless network) may be collocated at a single node.

In view of the descriptions provided in connection with FIGS. 1A-1D, and further in view of the following descriptions provided in connection with FIGS. 2-8, certain functions are depicted and, e.g., associated with various devices or nodes, for illustrative purposes. It will be understood that network functions, in whole or in part, may be performed by any suitable device and/or may be performed at any suitable node.

A WTRU, UE, or RAN node (e.g., a gNB) that is capable of communicating with AIoT devices over radio interface is denoted herein as a reader, or, more specifically, as an AIoT reader. A WTRU or UE that serves as a reader is denoted herein as a UE reader. It will be understood that a UE reader is a type of AIoT reader. A RAN node that serves as a reader is denoted herein as a BS reader as an AIoT capable RAN node.

FIG. 2 is a pair of illustrative block diagrams of components implementing the features of an AIoT function and an AIoT application function, in accordance with some embodiments of this disclosure. FIG. 2 is used to illustrate certain functionalities, e.g., which are named the AIoT function 200 (e.g., which may correspond to AIoTF 190) and the AIoT application function 210 (e.g., which may correspond to AIoT AF 192), for ease of illustration. Their illustration and naming need not define them as new or particular mobile network entities. That is, AIoT function 200 and/or AIoT application function 210 can be embedded in current or newly defined entities of a wireless network. The focus of this invention is to describe the functionalities that these functions serve. These functions need not be defined by their execution at a particular node of a wireless network, nor based on any other networks/devices of the wireless network with which these functions interact.

AIoT function 200 includes at least processor 201 and communication circuitry 202. AIoT application function 210 includes at least processor 211 and communication circuitry 212. AIoT function 200 and AIoT application function 210 can be coupled to each other (optionally by network exposure function, as shown in FIG. 1C), as shown, or can operate independent of the other. The processors of FIG. 2 may be configured to process the contents of incoming messages (e.g., as received from a WTRU or from any component of a core network) and generate outgoing messages (e.g., as may be sent to a WTRU or any component of a core network). The communication circuitry of FIG. 2 may be configured to receive any incoming messages and transmit any outgoing messages. The respective functions shown in FIG. 2 may also include, or be coupled to, memory and any other physical components as may be needed to support the operations of the respective processors and communication circuitries.

Illustrative functionalities of AIoT function 200 and AIoT application function 210 are further described below. For example, AIoT function 200 and AIoT application function 210 may be used to support various tracking applications. It is noted that AIoT devices can play a role in tracking applications, such as smart logistics and smart warehousing, because the low-cost, small-form, battery-lessness and durability of AIoT devices make them suitable to be attached to huge amounts of goods and facilitate more efficient goods identifying, sorting, tracking and inventory.

AIoT function (AIoTF) 200 is a network function that supports AIoT services, such as inventory tracking, warehouse commands, or any other AIoT services. AIoTF receives and handles AIoT service requests from AIoT application function (AIoT AF) 210. In some representative embodiments, the requests are sent from the AIoT AF to the AIoTF via an NEF, as shown in FIG. 1C. In some representative embodiments, the AIoTF may locate the AIoT RAN node (BS readers) or the one or more UE readers that can serve the target AIoT devices and that can forward the service requests to a RAN node. For example, the AIoTF may forward the service request the AIoT RAN node servicing the UE readers. The AIoT RAN node (if it is a BS reader) or the UE reader then carry out the AIoT service procedure (e.g., which may correspond to an operation to be performed based on an AIoT service request) over an AIoT air interface (e.g., air interface 116).

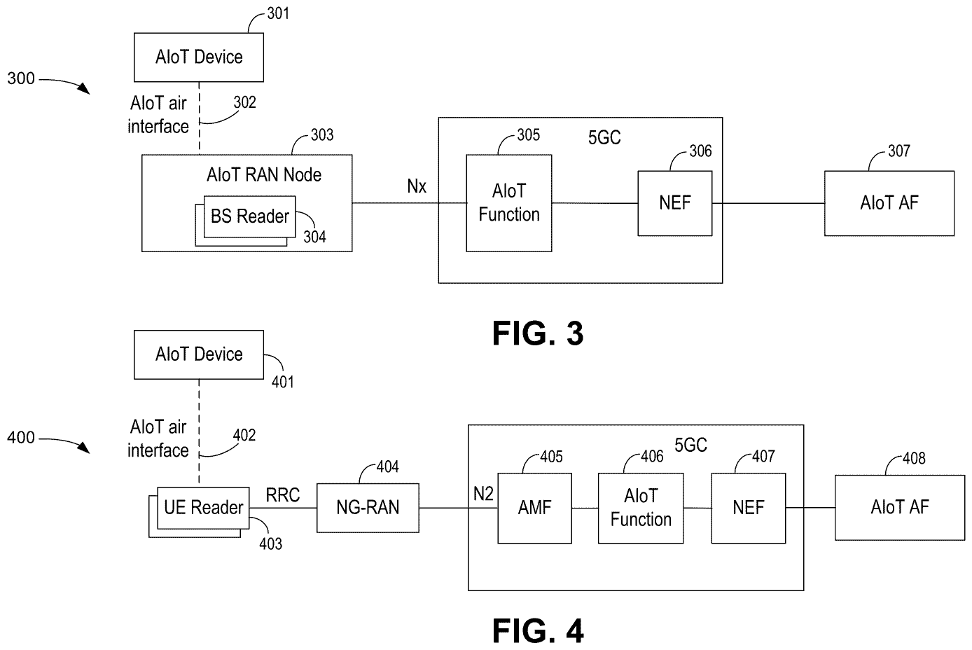

FIG. 3 is an illustrative system diagram of a first wireless network architecture 300 including an AIoT device 301, in accordance with some embodiments of this disclosure. AIoT device 301 is connected to AIoT RAN node 303 by AIoT air interface 302. Data may be sent to and from AIoT device 301 over AIoT air interface 302. AIoT RAN node 303 includes at least one BS reader 304, as shown. AIoT RAN node 303 is communicatively coupled (e.g., over any suitable network connection) to a 5G core (5GC) including AIoT function 305 and NEF 306, which are communicatively coupled to each other. In particular, AIoT function 305 communicates with AIoT RAN node 303, as shown. AIoT AF 307 may be located outside of the 5GC and is communicatively coupled to the 5GC through NEF 306.

FIG. 4 is an illustrative system diagram of a second wireless network architecture 400 including an AIoT device 401, in accordance with some embodiments of this disclosure. Compared to network architecture 300, network architecture 400 replaces the AIoT RAN node 303 with a UE reader 403. AIoT device 401 is connected to at least one UE reader 403 by AIoT air interface 402. As mentioned, the UE reader 403 may be any suitable WTRU. Data may be sent to and from AIoT device 401 over AIoT air interface 402. UE reader 403 is communicatively coupled (e.g., over radio resource control connection) to a next generation-radio access network (NG-RAN) node 404, which is communicatively coupled to a 5G core (5GC) including access and mobility management function (AMF) 405, AIoT function 406, and NEF 407. Those functions of the 5GC are communicatively coupled to each other. In particular, AMF 405 communicates with AIoT function 406, and AIoT function 406 communicates with NEF 407, as shown. AIoT AF 408 may be located outside of the 5GC and is communicatively coupled to the 5GC through NEF 4067

In connection with network architectures 300 and 400, or any other suitable network, a 5GC may receive an AIoT service request from an entity (e.g., AIoT AF) that is external to the 5GC. In turn, the 5GC may need to locate one or more AIoT readers that can reach one or more AIoT devices targeted in the AIoT service request and thereby execute the service request. When the AIoT reader is a UE reader, as shown in FIG. 4, it can be difficult for the 5GC to locate suitable UE readers because of the UE reader's mobility. In other words, the mobility of UE readers creates a situation where the network cannot be certain that the UE reader is in proximity of the target AIoT devices. Though the 5GC may utilize any suitable LoCation Service (LCS) to obtain the location of candidate UE readers, the LCS procedure is computationally intensive and introduces a delay, both of which may be exacerbated when the number of candidate UE readers is large. Furthermore, while existing location service procedures can be used to locate the UE, they cannot be used to determine whether a UE is in proximity of an AIoT Device with an uncertain location. In tracking applications, including warehousing and smart logistics, it is possible that many AIoT devices could have uncertain locations.

Accordingly, in certain representative embodiments of this disclosure, devices, systems, and methods are provided for locating potential UE readers and connecting them with a 5GC, or other suitable wireless network, for AIoT services. As used herein, it will be understood that any WTRU or UE performing UE reader functionality may be referred to as a UE reader.

In certain representative embodiments, approaches for UE reader selection are provided below based on the UE reader's AIoT service area. Relatedly, AIoT service area configurations are provided below.

A WTRU or UE that supports UE reader functionality may be pre-configured with a list of AIoT service areas including one or more AIoT service area entries. An AIoT service area indicates the location in which UE reader functionality is desired. UE reader functionality the UE may include AIoT reader activities, such as sending AIoT service requests to the target AIoT devices in the area, or such as receiving AIoT service responses from the target AIoT devices in the area. An AIoT service area may be identified using 3GPP network area identifiers such as cell ID, tracking area ID, gNB ID, or other suitable areas. An AIoT service area may otherwise be identified using formats such as a civic address, point coordinates that define a shape or an area, or any other suitable approach.

An AIoT service area may be associated with a specific AIoT service or application. If a UE reader supports multiple AIoT services or applications, then the UE reader may be configured with a list of AIoT service areas for each AIoT service or application.

A WTRU or UE that supports UE reader functionality may receive the AIoT service area configuration from a core network via NAS signaling, via other control plane signaling, or via any other suitable communication. For example, the UE may indicate a capability of supporting UE reader functionality (e.g., including an indication of supported AIoT services/applications) to the network, and the network may retrieve a list of AIoT service areas for each supported AIoT service from a network database (e.g., unified data management (UDM) or unified data repository (UDR) storage) where the user subscription data is stored. The service area configuration for a UE reader may be configured by a 3^{rd} party AIoT service provider using the network-provided APIs. For example, the AF of an AIoT service provider may use the NEF exposure service interface to configure such information in the network database.

A UE reader may support an AIoT service or application by hosting an application client or an application enabler client that supports interacting with an identified AIoT service or application. For example, the UE reader may communicate with at least one AIoT device based on the hosted application client or application enabler client.

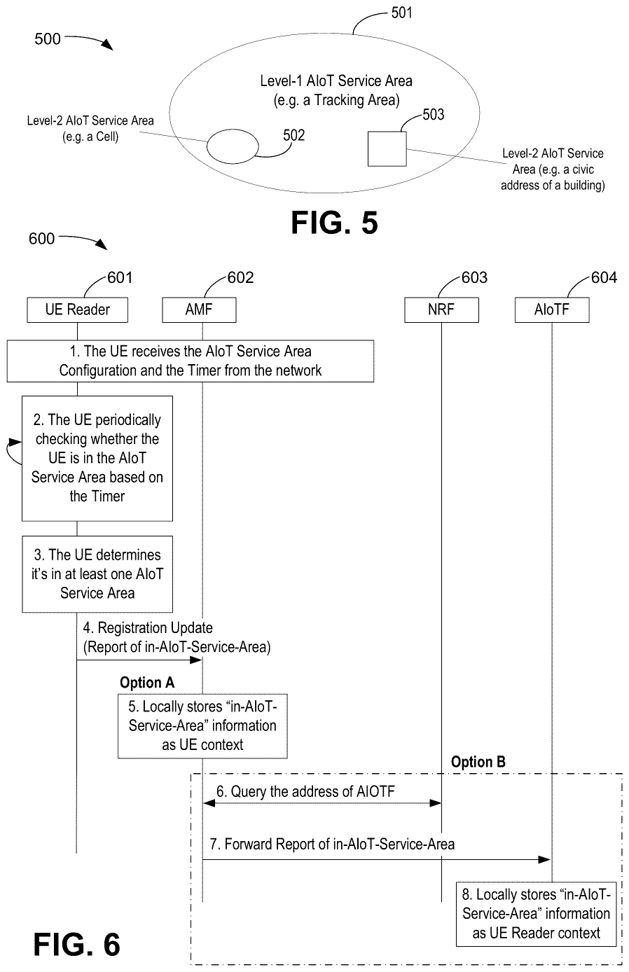

In certain representative embodiments, configuration information (e.g., an AIoT service area configuration), as received by the WTRU, may include multiple levels of AIoT service areas. FIG. 5 shows an illustrative depiction of a multi-level AIoT service area. Location 500 includes level-1 AIoT service area 501, which includes a first level-2 AIoT service area 502 and a second level-2 AIoT service area 503. As shown, for illustrative purposes only, level-2 AIoT service aera 502 may correspond to a cell of a network, and level-2 AIoT service aera 503 may correspond to a civic address (e.g., of a building). In practice, there may be any number of level-2 service areas within a given level-1 service area. While various service area shapes are shown in FIG. 5, it will be understood that each service area may be any suitable shape.

Consistent with the illustrative example shown in FIG. 5, a WTRU may be configured with a broader AIoT service area (level-1 areas), such as level-1 AIoT service area 501. This broader area may be one or more tracking areas, in whole or in part. Within the broader AIoT service area, there may be one or multiple smaller AIoT service areas (level-2 areas), such as level-2 AIoT service areas 502-503, which may correspond to one or more cell IDs, civic addresses, or any other suitable location identifiers. The level-2 areas may represent the specific areas in which the UE reader is desired to perform AIoT reader activities. Having the broader level-1 area configuration may provide the UE with the ability to easily check if it might be in range of the level-2 area, based on being (or not being) within the level-1 area. For example, if the level-1 area is a tracking area, then the UE can determine that it is in the configured level-1 area by reading the network's broadcasted system information, which includes the tracking area code. After the UE determines that it is in the level-1 area, the UE may determine to check (e.g., periodically) whether it is in the configured level-2 areas. If the UE is not in the level-1 area, then the UE doesn't need to check whether it's in the level-2 areas. That is, the UE may be configured to only perform periodic determinations of its presence in the level-2 area if it is in the level-1 area. This configuration can save energy and avoid unnecessary periodic location determinations.

The WTRU may be configured to automatically (e.g., periodically, according to one or more timers) and/or autonomously (e.g., without direct instructions from a wireless network) report whether it is in or out of the AIoT service area, including whether it enters or departs the AIoT service area, as further described below.

A WTRU or UE that supports UE reader functionality and that has received an AIoT service area configuration (which may be included within any configuration information) may determine whether or not the UE is within an AIoT service area and may report this determination to the network. In certain representative embodiments, the UE may periodically check whether it is in an AIoT service area based on a configured timer. In certain representative embodiments, the UE may periodically check whether it is in an AIoT service area by a UE mobility event (e.g., the mobility event being triggered based on the UE moving a certain distance). For example, when the UE performs a cell selection, or a handover, or detects that it has moved to a new tracking area, the UE may check whether it is in a configured AIoT service area. If the UE is configured with multi-level AIoT service area, the UE may be configured to only perform these checks when it is in the level-1 area.

Depending on the form of the configured AIoT service area, the UE may use various methods to determine whether it is in an AIoT service area. For example, if the configured AIoT service area takes the form of a tracking area identification or a cell ID, then the UE may use the TAI or cell ID of its current location (which can be read from the network broadcast system information, e.g., SIB-1) to determine whether the UE is in the AIoT service area. For another example, if the configured AIoT service area is a civic address or a polygon-shaped area described by multiple point coordinates, then the UE may use its GPS coordinates to determine whether it is in the AIoT service area. These determination approaches are not mutually exclusive; the UE may be configured to do both.

If a UE has determined that it is in at least one of configured AIoT service area, then the UE may be configured to check whether it moves out of the area. This check may be configured to occur periodically, based on a mobility event, or both.

In certain representative embodiments, the UE operates according to two timers. A first timer is for determining that the UE is located within the AIoT service area. A second timer is for determining that the UE is not located within the AIoT service area. In other words, two different timers may cause the UE to periodically check, with different frequencies, whether the UE is “out of area” and whether the UE is “in the area”. Consistent with such an approach, in certain representative embodiments, it may be desirable to quickly detect when a UE leaves an AIoT service area, but it might not be as desirable to quickly detect when a UE enters an AIoT service area (or vice versa). Thus, two timers that are used for periodically checking “in the area” and “out of area” may be programmed with different values.

When a UE determines that it is in or out of at least one of the configured AIoT service areas, the UE may report this information to a wireless network. The information may include the AIoT service area that that UE is in, is out of, has entered, or has left. If the configured AIoT service area is a multi-level service area, then the UE may be configured to only report the determination information to the wireless network when the UE is in at least one of the level-2 service areas.

As mentioned, the UE may report the determination information to the wireless network using a NAS message to the relevant AMF. That is, the UE may transmit information including an indication that the UE is located within the AIoT service area, or an indication that the UE is not located within the AIoT service area. The information may also include a UE identifier (e.g., 5G-GUTI), a UE reader identity, a list of one or more current AIoT service areas that the UE is currently in, the last visited AIoT service area, a particular AIoT service, an application identifier associated with the AIoT service area, a timestamp when the report is sent, at least one AIoT device with which the UE can communicate, any other suitable information, or any combination thereof.

For example, the wireless network (e.g., at the node executing the AMF, or at any other suitable location), may store this information as part of the UE context. For another example, the AMF may query a network repository function (NRF) and cause the NRF to locate the AIoTF that serves the reported AIoT service or application in the AIoT service area. Accordingly, the UE may further cause the NRF to forward the information to the AIoTF. The AIoTF may locally store the information transmitted from the UE as the UE reader context. For another example, the AMF may forward the information to an operation, administration, and maintenance (OAM) system.

FIG. 6 is a flow diagram of an illustrative process 600 of a WTRU reporting its location as being within an AIoT service area, in accordance with some embodiments of this disclosure. Process 600, as shown, includes UE reader 601 (e.g., any WTRU 102, any other WTRU described in this disclosure, or any other suitable WTRU), AMF 602, NRF 603, and AIoTF 604 (e.g., AIoTF 190 or 200). Process 600 may, e.g., be executed in connection with the wireless network architectures of FIG. 1A-D or FIG. 4. Process 600 may include use of at least one of the network functions shown in FIG. 2 and may incorporate a multi-level AIoT service area, as shown in FIG. 5.

At step 1 of process 600, the UE reader 601 receives the AIoT service area configuration (and optionally, one or more timers associated with determining whether the UE reader 601 is in an AIoT service area) from the network (e.g., from AMF 602). The AIoT service area configuration may include a list of AIoT service areas including one or more AIoT service areas, each of which may be associated with a level (e.g., level-1 or level-2, as shown in FIG. 5). Moreover, each AIoT service area may be associated with a specific AIoT service or application identifier. As mentioned, the UE reader 601 may receive one or more timers that the UE reader 601 can use to periodically check whether it is within or outside of the AIoT service area. Generally, but not necessarily, this period check will be with reference to a level-2 AIoT service area.

In certain representative embodiments, the UE reader 601 receives the AIoT service area configuration from the wireless network in response to the UE reader 601 requesting the AIoT service area configuration. That request for AIoT service area configuration may include an AIoT service capability of the UE reader 601. The AIoT service capability may include an identity of the AIoT services or the AIoT applications that the UE reader 601 can support (i.e., for which the UE reader 601 can cause an operation to occur). The network (e.g., the AIoTF 604) may use the AIoT service capability information to determine specific configuration information (e.g., specific AIoT services, or at least one specific AIoT service area) or to determine a specific AIoT service request for the UE reader 601.

At step 2 of process 600, based on a timer (e.g., as received at step 1 of process 600, or as otherwise stored in memory at the UE reader 601, e.g., in connection with a particular AIoT service area or AIoT application), the UE periodically checks whether it is within the configured AIoT service areas. That is, each time the timer reaches zero, the UE reader 601 evaluates whether it is within an AIoT Service area. The timer may be configured based on information that was received at step 1 of process 600, e.g., as part of the AIoT service area configuration.

At step 3 of process 600, the UE reader 601 determines that it is within at least one AIoT service area of the configured AIoT service areas. For example, when the timer expires, the UE reader 601 may compare the identity of the cell region that it is camped on to a cell identifier in the AIoT service area configuration. If those two cell identifiers are the same, then the UE reader 601 determines that it is within the AIoT service area.

At step 4 of process 600, the UE reader 601 initiates a NAS procedure, e.g., a registration update or an uplink (UL) NAS transport. The UE reader 601 may initiate this NAS procedure to communicate with the AMF 602 serving the network connection of the UE reader 601. The NAS procedure may report (e.g., provide an indication) that UE reader 601 is within at least one of the configured AIoT service areas. The report may also include any one or more properties of UE reader 601: a UE Identifier, a UE reader identity, one or more particular AIoT service areas that the UE is currently within, a last visited AIoT service area, AIoT service capability information (e.g., an AIoT service or application identifier associated with the AIoT service area), a current timestamp, or any other suitable UE information.

In certain embodiments, at step 4 of process 600, UE reader 601 may report that it is outside of all configured AIoT service areas. That is, the UE reader 601 may cause AIoTF 604 to route the message of step 1 of process 600 to another AMF 602, or at least to another UE reader 601. In connection with reporting that it is outside of all configured AIoT service areas, the UE reader 601 might also report its current location to the network.

Following step 4 of process 600 is Option A (e.g., including step 5 of process 600) and/or Option B (e.g., including steps 6-8 of process 600). Options A and B pertain to storing information related to how UE reader 601 can support an AIoT service request. Options A and B are complementary, i.e., both of them can be performed, although, in certain representative embodiments (e.g., to reduce network overhead), only one of them may be performed.

At step 5 of process 600, AMF 602 stores the information transmitted by UE reader 601. For example, the transmitted information may be stored as part of the UE context information.

At step 6 of process 600, AMF 602 queries the NRF 603 to determine the network address of AIoTF 604 that is responsible for the reported AIoT service area. The query may be based on the information transmitted by the UE reader 601. The query may include the transmitted AIoT service area, the transmitted AIoT service, or a transmitted application identifier associated with the AIoT service area. NRF 603 returns to AMF 602 the address of the AIoTF 604.

At step 7 of process 600, AMF 602 forwards the report to the AIoTF 604 as identified by the address provided by NRF 603 in step 6 of process 600. In this report, in addition to the original information transmitted by UE reader 601, AMF 602 may also include its own AMF identifier or address.

At step 8 of process 600, AIoTF 604 stores the transmitted information as the UE reader context. In certain representative embodiments, AIoTF 604 configures an AIoT service request based on the UE reader context and causes the AIoT service request to be received by UE reader 601. In turn, UE reader 601 causes a UE reader operation to be performed based on the AIoT service request.

In certain representative embodiments, a WTRU needs to enter a particular working mode for serving as a UE reader, e.g., UE reader mode. Accordingly, the WTRU may be configured to execute process 600 based on entering UE reader mode. For example, the WTRU may be configured to periodically enter UE reader mode and check for whether it can support an AIoT service request, e.g., based on executing process 600.

Process 600 may be applied to any number of UE readers 601. At step 1 of process 600, AMF 602 (or any other wireless network node) may request a number of candidate UE readers 601 to each determine and transmit their current AIoT service areas. The AMF 602 may initiate that request, or the AIoTF 604 may initiate that request by making a corresponding request from to AMF 602 to provide a list of available UE readers 601 in the target area. Such requests may be sent by the AMF 602 to the UE readers 601 over a downlink (DL) NAS message. If initiated by the AIoTF 6054, the AIoTF 604 may send the request to one or more AMFs 602, causing those AMFs 602 to forward the request to the UE readers 601.

As described below, certain network configurations may be applied to select one or more WTRUs to operate as UE readers.

When a network receives an AIoT service request, e.g., from any application function (including, but not limited to, AIoT AF 210), the request may indicate a target area in which the target AIoT devices are located. The request may also include target device identification information, such as one or multiple permanent device identifiers, or a bitmask that can be matched by one or more devices (e.g., of a group of devices). The AIoT service request may be an AIoT inventory request (e.g., for a list of suitable UE readers) or an AIoT command request (e.g., for a particular AIoT service), may be forwarded to the AIoTF 604 that serves the target area.

The AIoTF 604 may need to determine whether NG-RAN readers or UE readers are available to handle the incoming AIoT service request. For example, a local network policy may set one type of reader as being higher priority than the other type of reader. In particular, the network may choose NG-RAN readers to handle the service request if NG-RAN readers are available for the target area (e.g., for applications with no or limited mobility of AIoT devices). It is possible that UE readers are only chosen when there are no BS readers available for the target area. Alternatively, it is possible that UE readers are chosen, even with the availability of one or more BS readers, because the AIoT service is associated with high mobility. The priority of reader types (NG-RAN reader or UE reader) may also be associated with the AIoT service or application (e.g., identified by the application function ID that initiates the request). For example, for some application functions, the BS readers may always be considered first, and for other application functions, the UE readers may be considered first.

If the network (e.g., AIoTF) determines to choose UE readers (as opposed to BS readers) to handle the AIoT service request, and the network has UE reader contexts available (e.g., as per Options A or B of process 600), then the AIoTF may look up the local UE reader context to determine UE readers that are available in the target area. For example, a UE reader may be determined as available for serving a request in a target area based on the UE reader context and/or based on the UE being inside an AIoT service area which touches the target AIoT service request area. The AIoTF may also use the timestamp information in the UE reader context to determine whether the stored information is still valid. For example, the AIoTF may have a local configuration of time threshold (e.g., of 30 minutes). If the timestamp in the UE reader context indicates that the information was received or updated less than 30 minutes ago, then the UE reader information is determined to be reliable, and that UE reader can be considered for an ongoing AIoT service request. Based on such a determination, the AIoTF may forward the AIoT service request to the AMF (whose identifier or address may also be stored as part of UE reader context) serving the UE reader, indicating the selected UE identifiers to the AMF. In turn, the AMF will further forward the request to the selected UE readers.

In certain representative embodiments, the AIoTF stores a list of potential UE readers that might be located within the AIoT service area. The list of potential UE readers might be generated based on certain movement patterns for the UE readers detected by the AMF or detected by other network functions of the CN. Prior to causing an AIoT service area configuration to be sent out, the AIoTF can be configured to check (based on the list of potential UE readers) for whether any UE reader is expected to be in the AIoT service area at the current time.

In certain representative embodiments, the AIoTF may locate one or multiple AMFs that serve the target area (e.g., via NRF query) and request the AMFs to report the available UE readers. The AIoTF may provide a target area and an AIoT service or application identifier to the AMF, and the AMF may then check its local UE context to find the capable UE readers that are currently in the target area (e.g., including or overlapping with the AIoT service area). The AMF can then return a list of available UE readers, optionally with UE context or other UE reader information, to the AIoTF. Such UE reader information may include the UE identifier, UE reader identity, the AIoT service area that the UE is currently within, UE service capability, or other suitable UE information. Similarly, the AMF may use the timestamp information to determine whether the stored UE reader information is still valid, and the AMF may filter out the UE readers with information that is determined to be invalid (e.g., older than a certain threshold). Based on the list of UE reader Information received from one or multiple AMFs, the AIoTF may further select one UE reader, or any suitable subset or all the available UE readers reported by the AMFs, and forward the AIoT service request (optionally, with selected UE identifiers) to the AMFs serving the one or more selected UEs. The AMFs can then forward the request to the UE readers, e.g., using a NAS message.

In certain representative embodiments, the AIoTF may directly forward the AIoT service request to the AMFs without requesting a report of the available UE readers. The AMF may then, based on the target area associated with the service request and based on the stored UE reader information, determine suitable UE readers (e.g., based on location, capability information, any aspect of the UE reader context, or any other suitable information) and forward the service request to those UE readers.

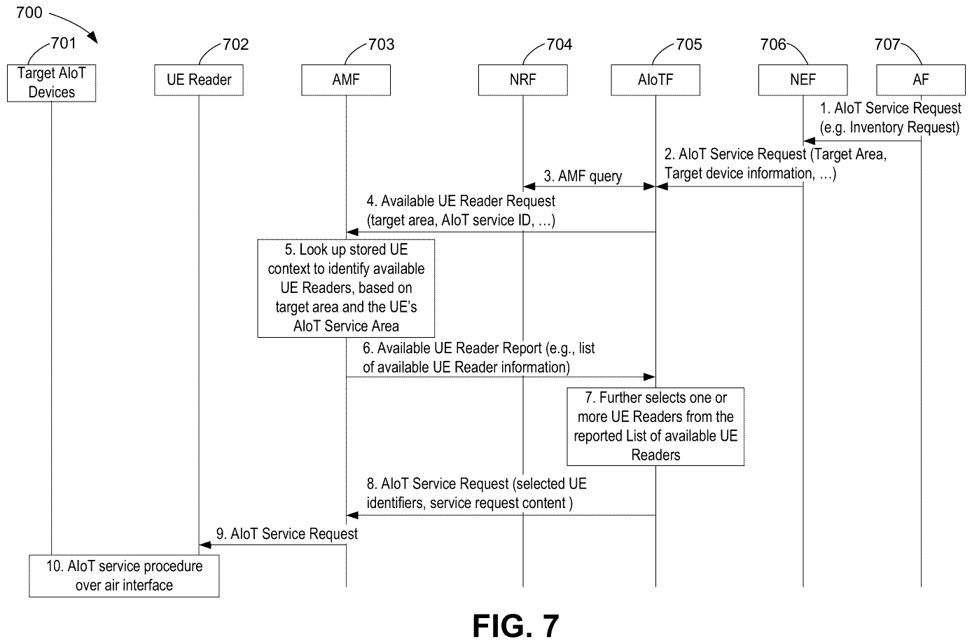

FIG. 7 shows additional details for how a network may be configured to select WTRUs to operate as UE readers. FIG. 7 is a flow diagram of an illustrative process of a core network transmitting an AIoT service request and a WTRU causing operations to be performed based on the AIoT service request. Process 700, as shown, includes one or more target AIoT devices 701, one or more UE reader 702 (e.g., any WTRU 102, any other WTRU described in this disclosure, UE reader 601, or any other suitable WTRU), AMF 703 (e.g., which may be AMF 602), NRF 704 (e.g., which may be AMF 603), AIoTF 705 (e.g., AIoTF 190, 200, or 604), NEF 706, and application function (AF) 707 (e.g., AIoTAF 192 or 210, or any other suitable application function). Process 700 may, e.g., be executed in connection with the wireless network architectures of FIG. 1A-D or FIG. 4. Process 700 may, e.g., be executed in response to execution of process 600 (e.g., through completion of at least one of Options A and B). Process 700 may be executed in connection with the wireless network architectures of FIG. 1A-D or FIG. 4. Process 700 may include use of at least one of the network functions shown in FIG. 2 and may incorporate a multi-level AIoT service area, as shown in FIG. 5.

At step 1 of process 700, NEF 706 (e.g., as is associated with a 5GC) receives an AIoT service request, e.g., an inventory request, from AF 707. The AIoT service request may indicate the target area in which the target AIoT devices 701 are located, and/or device information (e.g., one or more permanent device identifiers, or a bitmask representing a group of AIoT devices) associated with the target AIoT devices 701.

At step 2 of process 700, NEF 706 may locate and query an AIoTF 705 that can support the AIoT service request, e.g. by querying the NRF 704 (though this query is not directly shown it will be understood that the NRF 704 may act as an intermediary in the communication between NEF 706 and AIoTF 705). For example, the AIoTF 705 may be identified (e.g., based on a query of NRF 704, or based on any other suitable approach) based on the target AIoT service area. As shown, step 2 of process 700 includes forwarding the relevant AIoT service request to the selected AIoTF 705.

At step 3 of process 700, AIoTF 705 queries NRF 704 to determine the one or more AMFs 703 that serve the target AIoT service area. In response to this query, the AIoTF 705 may receive one or more AMF identifiers or addresses from the NRF 704.

At step 4 of process 700, AIoTF 705 causes the AMF 703 identified the preceding step to provide the available UE reader information (e.g., an available UE reader request is sent to the AMF 703). To facilitate how the AMF 703 can look up the stored UE context, the AIoTF 705 may provide, within the UE reader request, the target AIoT service area, an AIoT service identifier (e.g., an AF ID), any other suitable information, or any combination thereof.

At step 5 of process 700, AMF 703 may look up its stored UE context and identify the available UE readers 702 by matching the current AIoT service area of each UE reader 702 to the received target AIoT service area. The matching may be further based on the particular AIoT service or application identifier, as compared to respective AIoT service capabilities of the available UE readers 702. AMF 703 may be configured to determine that a UE reader 702 is an available UE reader if the UE reader's current AIoT service area is within, or overlapping with, the target AIoT service area.

At step 6 of process 700, AMF 703 returns a list of available UE reader information to the AIoTF 705. The UE reader information may include the UE Identifier, UE reader identity, the AIoT service area that the UE is currently in, AIoT service capability, timestamp, any other suitable UE information, or any combination thereof.

At step 7 of process 700, AIoTF 705 may select one or more UE readers 702 based on the UE reader information received from the AMF 703. The AIoTF 705 may also store the AMF-provided UE information for use in future UE reader selection (e.g., to reduce the number of times that the AIoTF has to request the information from the AMF).

At step 8 of process 700, AIoTF 705 forwards the AIoT service request to the serving AMFs 703 of the selected UE readers 702, and indicates the selected UE identifiers to the AMFs.

At step 9 of process 700, AMF 703 forwards the AIoT service request to the selected UE reader 702 (e.g., via the NG-RAN supporting the UE reader 702).

At step 10 of process 700, the selected UE reader performs an operation based on the AIoT service request. The operation typically includes communicating with target AIoT devices 701. For example, the UE reader 702 may receive, using an over-air interface, device data from at least one target AIoT device 701, and the UE reader 702 may further provide that device data to the wireless network.

The device data from the target AIoT device 701 may include a location, a status (e.g., scanned-in, scanned-out, picked up, dropped off, or any other suitable smart logistics identification), a temperature, any other environmental data, an indication of contents associated with the device (e.g., where the AIoT device 701 is affixed to a container, and the indication of contents identifies what is inside the container), any other data recorded by the AIoT device, or any combination thereof.

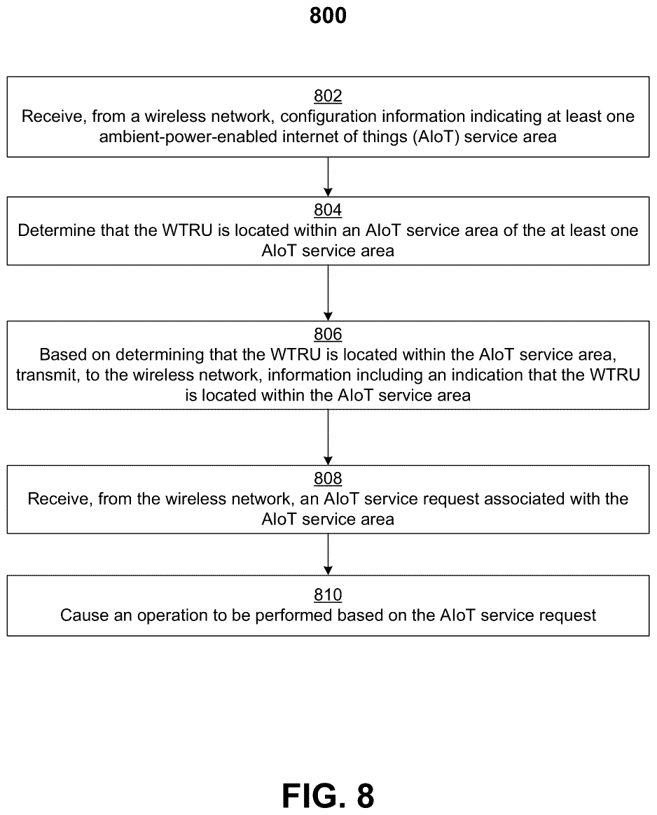

FIG. 8 is a flow diagram of an illustrative process of a WTRU receiving an AIoT service request and causing operations to be performed based on the AIoT service request, in accordance with some embodiments of this disclosure. Process 800 may, e.g., be executed by a WTRU (e.g., any WTRU 102, any WTRU acting as a UE reader 403, 601, or 702, or any other suitable WTRU) in connection with the wireless network architectures of FIGS. 1A, 1C, 1D, or FIG. 4. Execution of process 800 may, e.g., include execution of at least some of process 600, and/or execution of at least some of process 700. Process 800 may be executed in connection with the network functions shown in FIG. 2 and may incorporate a multi-level AIoT service area, as shown in FIG. 5.

At step 802, the WTRU receives, from a wireless network, configuration information indicating at least one ambient-power-enabled internet of things (AIoT) service area. The operations at step 802 may, e.g., correspond to step 1 of process 600.

At step 804, the WTRU determines that the WTRU is located within an AIoT service area of the at least one AIoT service area. The operations at step 804 may, e.g., correspond to step 3 (and optionally, also step 2) of process 600. The operations at step 804 may, e.g., occur in response to the occurrence of a WTRU mobility event (i.e., the WTRU has moved more than a threshold amount of distance). The operations at step 804 may, e.g., occur in response to the one or more timers counting down to zero, where a periodic location determination occurs when each of the one or more times hits zero, and where the use of multiple timers may include a first timer associated with entering the AIoT service area and a second timer associated with exiting the AIoT service area.

At step 806, the WTRU, based on determining that the WTRU is located within the AIoT service area, transmits, to the wireless network, information including an indication that the WTRU is located within the AIoT service area. The operations at step 806 may, e.g., correspond to step 4 of process 600. The information may include a location of the WTRU, an AIoT service level that the WTRU is within, an AIoT service capability of the WTRU, other UE context or UE identify information associated with the WTRU, or any combination thereof.

At step 808, the WTRU receives, from the wireless network, an AIoT service request associated with the AIoT service area. Step 808 may include either (or both) of Options A and B of process 600. Step 808 may include one or more of steps 1-9 of process 700 occurring at the wireless network with which the WTRU communicates. For example, the AIoT service request may be based on an AIoT function of the wireless network selecting the WTRU for the AIoT service.

At step 810, the WTRU causes an operation to be performed based on the AIoT service request. Step 810 may, e.g., correspond to step 10 of process 700, including receiving AIoT device data (e.g., via an over-air interface) and providing the AIoT device data to the wireless network with which the WTRU communicates.

In certain representative embodiments, a WTRU operates as a UE reader and performs the following actions to assist the network to select the UE reader for AIoT service requests: receive a configuration of AIoT service areas which indicates the location or the area where the UE reader is supposed to perform AIoT reader activities; monitor whether the WTRU is within the configured AIoT service areas, e.g., by periodically checking the current location against the configured areas; and report to the network whether the WTRU is within the configured AIoT service areas. Accordingly, the WTRU may cause the wireless network to select the WTRU for UE reader services, e.g., to support an AIoT service request.

In certain representative embodiments, an AIoTF in the 5GC performs the following actions to select the UE reader for AIoT service requests: receive an AIoT service request from an AF, where the request indicates a target AIoT service area; locate one or more AMFs that serve the target AIoT service area and request the AMF to provide a list of available UE readers; receive a list of available UE readers from the AMF, where the AMF selects the available UE readers by determining WTRUs that are in a current AIoT service area which overlaps with the target AIoT service area; select one or more UE readers based on the list of available UE readers; and forward the AIoT service request to the selected one or more UE readers.

In certain representative embodiments, a method performed by a wireless network includes determining at least one WTRU (e.g., based on determining that the WTRU is capable of UE reader functionality) to support an AIoT service request, transmitting the AIoT service request to the at least one WTRU, receiving a registration from the WTRU based on the AIoT service request, and performing an operation based on the registration. For example, performing the operation may include receiving, from the WTRU, device data from at least one AIoT device. Performing the operation may also include determining information about the AIoT device based on the device data.

In certain representative embodiments of that method performed by a wireless network, the AIoT service request includes a target AIoT service area, and determining the at least one WTRU is based on the AIoT service area. For example, the wireless network may receive a list of multiple WTRUs associated with the AIoT service area, and may determine that at least one WTRU based on the list of multiple WTRUs (e.g., based on which one or more of the at least one WTRU are determined to have a sufficiently high likelihood of actively being within the AIoT service area).

In certain representative embodiments of that method performed by a wireless network, the AIoT service request includes an AIoT service capability, and determining the at least one WTRU is based on the AIoT service capability.

In certain representative embodiments, that method performed by a wireless network also includes storing, in at least one UE reader context associated with the at least one WTRU, information indicated in the registration, where performing the operation is based at least in part on the stored information.

In certain representative embodiments, that method performed by a wireless network also includes determining that there are no BS readers available to support the AIoT service request.

Throughout the specification the phrases “in response to” and “based on” shall be understood to have a broad meaning unless stated otherwise. For example, “in response to” can refer to a step that is in direct or indirect response to a prior step, and “based on” can refer to a step that is based at least in part on a prior step.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent processes and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular processes or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6, 35 U.S.C. § 112(f) or means-plus-function claim format, and any claim without the terms “means for” is not so intended.

What is claimed is:

1. A method performed by a wireless transmit/receive unit (WTRU), the method comprising:
receiving, from a wireless network, configuration information indicating at least one ambient-power-enabled internet of things (AIoT) service area;
determining that the WTRU is located within an AIoT service area of the at least one AIoT service area;
based on determining that the WTRU is located within the AIoT service area, transmitting, to the wireless network, information comprising an indication that the WTRU is located within the AIoT service area;
receiving, from the wireless network, an AIoT service request associated with the AIoT service area; and
causing an operation to be performed based on the AIoT service request.

2. The method of claim 1, wherein the operation comprises:
receiving, using an over-air interface, device data from at least one AIoT device; and
providing the device data to the wireless network.

3. The method of claim 1, wherein the transmitted information further comprises the AIoT service area or an AIoT service capability of the WTRU.

4. The method of claim 1, wherein:
determining that the WTRU is located within the AIoT service area comprises determining that the WTRU is located within the AIoT service area according to a timer.

5. The method of claim 4, wherein:
the timer comprises a first timer;
a first periodic determination based on the first timer causes the WTRU to determine whether the WTRU has left the AIoT service area; and
a second periodic determination based on a second timer causes the WTRU to determine whether the WTRU has entered the AIoT service area.

6. The method of claim 1, wherein the determining that the WTRU is located within the AIoT service area is based on a WTRU mobility event occurring.

7. The method of claim 1, wherein the AIoT service area comprises multiple levels, and the transmitted information further comprises a particular level of the multiple levels.

8. The method of claim 1, further comprising requesting, from the wireless network, the configuration information.

9. The method of claim 1, wherein the transmitted information further comprises a request for an AIoT configuration associated with the AIoT service area, and wherein the AIoT service request comprises the AIoT configuration associated with the AIoT service area.

10. The method of claim 1, wherein the AIoT service request comprises a WTRU identifier, and wherein causing the operation to be performed is further based on determining that the WTRU identifier is associated with the WTRU.

11. A wireless transmit/receive unit (WTRU) comprising processing circuitry and communication circuitry, the WTRU configured to:
receive, from a wireless network, configuration information indicating at least one ambient-power-enabled internet of things (AIoT) service area;
determine that the WTRU is located within an AIoT service area of the at least one AIoT service area;
based on determining that the WTRU is located within the AIoT service area, transmit, to the wireless network, information comprising an indication that the WTRU is located within the AIoT service area;
receive, from the wireless network, an AIoT service request associated with the AIoT service area; and
cause an operation to be performed based on the AIoT service request.

12. The WTRU of claim 11, wherein the operation comprises:
receiving, using an over-air interface, device data from at least one AIoT device; and
providing the device data to the wireless network.

13. The WTRU of claim 11, wherein the transmitted information further comprises the AIoT service area or an AIoT service capability of the WTRU.

14. The WTRU of claim 11, wherein:
to determine that the WTRU is located within the AIoT service area comprises to determine that the WTRU is located within the AIoT service area according to a timer.

15. The WTRU of claim 14, wherein:
the timer comprises a first timer;
a first periodic determination based on the first timer causes the WTRU to determine whether the WTRU has left the AIoT service area; and
a second periodic determination based on a second timer causes the WTRU to determine whether the WTRU has entered the AIoT service area.

16. The WTRU of claim 11, wherein to determine that the WTRU is located within the AIoT service area is based on a WTRU mobility event occurring.

17. The WTRU of claim 11, wherein the AIoT service area comprises multiple levels, and the transmitted information further comprises a particular level of the multiple levels.

18. The WTRU of claim 11, wherein the WTRU is further configured to request the configuration information.

19. The WTRU of claim 11, wherein the transmitted information further comprises a request for an AIoT configuration associated with the AIoT service area, and wherein the AIoT service request comprises the AIoT configuration associated with the AIoT service area.

20. The WTRU of claim 11, wherein the AIoT service request comprises a WTRU identifier, and wherein causing the operation to be performed is further based on determining that the WTRU identifier is associated with the WTRU.
